(19) United States
(12) Patent Application Publication
(10) Pub. No.: US 2007/0199921 A1
(43) Pub. Date: Aug. 30, 2007

(54) Method and apparatus for manufacturing display device

(75) Inventor: Nam-seok Roh, Gyeonggi-do (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/712,300

(22) Filed: Feb. 27, 2007

(30) Foreign Application Priority Data
Feb. 27, 2006 (KR) 10-2006-0018620

(51) Int. Cl. B05C 1/00

(52) U.S. Cl. 216/52; 118/200

(57) ABSTRACT

A manufacturing apparatus of a display device, comprises: a stage on which an insulating substrate having an organic layer is seated; a mold which moves up and down above the insulating substrate, and forms a pattern on the organic layer; a first driver which aligns and moves the mold upwards and downwards; a mold aligner which holds and realigns the mold while the mold is molded to the organic layer; a second driver which drives the mold aligner; and a controller which controls the first and second drivers.

### CROSS-REFERENCE TO RELATED APPLICATIONS

This application claims the benefit of Korean Patent Application No. 2006-0018620, filed on Feb. 27, 2006, in the Korean Intellectual Property Office, the disclosure of which is incorporated herein by reference.

### BACKGROUND OF THE INVENTION

1. Field of the Invention

The present invention relates to method and apparatus for manufacturing a display device.

2. Description of the Related Art

Generally, a liquid crystal display (LCD) device is classified as transmission, semi-transmission or a reflection type display according to the light source employed. In the transmission type, a backlight unit is provided behind the liquid crystal panel to transmit light to the liquid crystal panel. The reflection type uses natural light and restricts the usage of the backlight unit which consumes up to 70% of the power used, thereby reducing power consumption. The semi-transmission type is a compromise between the transmission type and the reflection type. The semi-transmission type uses natural light and a backlight unit, thereby providing sufficient brightness in the user environment regardless of ambient conditions.

In the reflection type or the semi-transmission type liquid crystal display device, an organic layer is formed on a substrate having a thin film transistor. An uneven pattern is formed on the organic layer. A reflection layer is formed on the entire surface of the uneven pattern to make a reflection type LCD device and on a portion of the uneven pattern to make a semi-transmission type LCD device. The uneven pattern allows light to be irregularly reflected or to be diffused, and increases the reflection efficiency of light. To form the uneven pattern, a display device mold having a predetermined pattern is aligned on the organic layer and pressed.

Since the organic layer is fluid organic material which is liquid, the display device mold may be distorted while being pressed on the organic layer and cause misalignment.

### SUMMARY OF THE INVENTION

Accordingly, it is an aspect of the present invention to provide a manufacturing apparatus for a display device which improves the yield of a pattern formed on an organic layer, and a method of manufacturing a display device using the same.

In accordance with an aspect of the present invention the manufacturing apparatus comprises: a stage on which an insulating substrate having an organic layer is seated; a mold which moves up and down above the insulating substrate, and forms a pattern on the organic layer; a first driver which aligns and moves the mold upwards and downwards; a mold aligner which holds and realigns the mold while the mold is molded to the organic layer; a second driver which drives the mold aligner; and a controller which controls the first and second drivers.

According to the embodiment of the present invention, the mold aligner comprises a holder which holds the mold, and a supporting frame which supports the holder.

According to the embodiment of the present invention, the holder comprises one of a vacuum chuck and a clamp.

According to the embodiment of the present invention, the manufacturing apparatus further comprises: a camera which checks an alignment state of the mold.

According to the embodiment of the present invention, the mold comprises a pattern forming part which includes an uneven pattern on a side thereof, and an even part which is formed around the pattern forming part, and the holder holds a second side of the mold corresponding to the even part.

According to the embodiment of the present invention, the controller controls the first driver to align the mold on the insulating substrate and presses the mold toward the insulating substrate.

According to the embodiment of the present invention, the controller controls the second driver and realigns the mold while checking the alignment state of the mold by the camera.

According to the embodiment of the present invention, the pattern forming part comprises at least one organic layer removing part which protrudes from the uneven pattern thereof.

According to the embodiment of the present invention, a gate pad, a data pad and a drain electrode are provided between the insulating substrate and the organic layer, and the controller aligns the mold to make the organic layer removing part to correspond to at least one of the gate pad, the data pad and the drain electrode.

According to the embodiment of the present invention, the mold comprises an alignment key to be aligned on the insulating substrate.

The foregoing and/or other aspects of the present invention can be achieved by providing a method of manufacturing a display device, comprising: providing an insulating substrate which comprises a organic layer; aligning a mold having a pattern forming part on the passivation layer; forming an uneven pattern on the passivation layer corresponding to the pattern forming part by pressing the mold toward the insulating substrate; holding and realigning the mold; and separating the mold from the organic layer.

According to the embodiment of the present invention, the method further comprises: curing the organic layer between the realigning the mold and the separating the mold.

According to the embodiment of the present invention, the organic layer comprises a polymer organic material and cured by at least one of heat and light.

According to the embodiment of the present invention, the method further comprises: using a camera which checks an alignment state of the mold.

According to the embodiment of the present invention, the mold aligner comprises a holder to hold the mold and a supporting frame to support the holder, and the realigning the mold comprises holding a circumference of the mold by the holder, and aligning the mold while checking the alignment state of the mold by the camera.

According to the embodiment of the present invention, the holder comprises one of a vacuum chuck and a clamp.

According to the embodiment of the present invention, the mold comprises the pattern forming part which includes an uneven part on a side thereof, and an even part which is provided around the pattern forming part, and the hold holds a second side of the mold corresponding to the even part.

According to the embodiment of the present invention, the method, before the forming the organic layer, further comprises: forming a gate wire which extends in a predetermined direction, and a data wire which insulatingly intersects the gate wire and defines a pixel region on the insulating substrate; and forming a thin film transistor on an intersection of the gate wire and the data wire.

According to the embodiment of the present invention, the pattern forming part comprises at least one organic layer removing part which protrudes the uneven pattern, the gate wire comprises a gate pad, and the data wire comprises a data pad and a drain electrode, and the realigning the mold comprises realigning the mold to make the organic layer removing part correspond to at least one of the gate pad, the data pad and the drain electrode.

According to the embodiment of the present invention, the method, after curing the organic layer, further comprises: forming a pixel electrode corresponding to the pixel region on the organic layer, and forming a reflection layer on at least a portion of the pixel electrode.

### BRIEF DESCRIPTION OF THE DRAWINGS

The above and/or other aspects and advantages of the present invention will become apparent and more readily appreciated from the following description of the embodiments, taken in conjunction with the accompany drawings, in which:

FIG. 1 is a sectional view of a manufacturing apparatus of a display device according to an embodiment of the present invention;

FIG. 2 is a perspective view of the manufacturing apparatus of the display device according to the embodiment of the present invention;

FIG. 3 is a control block diagram of the manufacturing apparatus of the display device according to the embodiment of the present invention;

FIG. 4A is a layout diagram of a thin film transistor substrate which is manufactured according to an embodiment of the present invention;

FIG. 4B is a sectional view of the thin film transistor substrate, taken along line IVb-IVb in FIG. 4A; and

FIGS. 5A to 5E illustrate a manufacturing method of the display device according to an embodiment of the present invention.

### DETAILED DESCRIPTION OF EMBODIMENTS

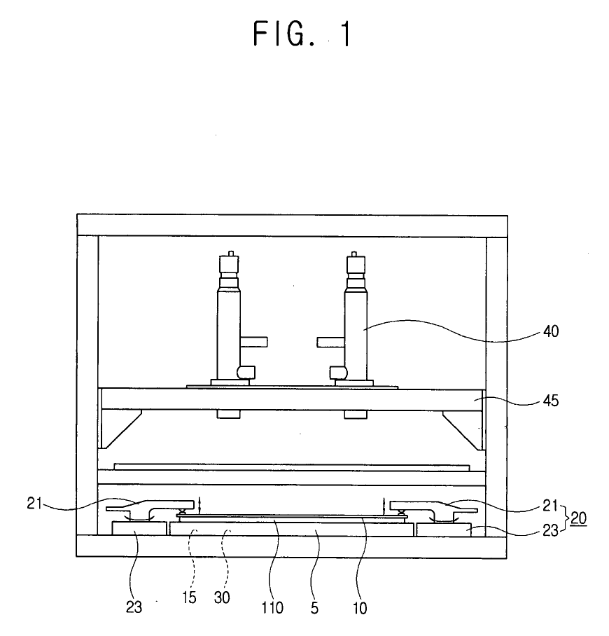

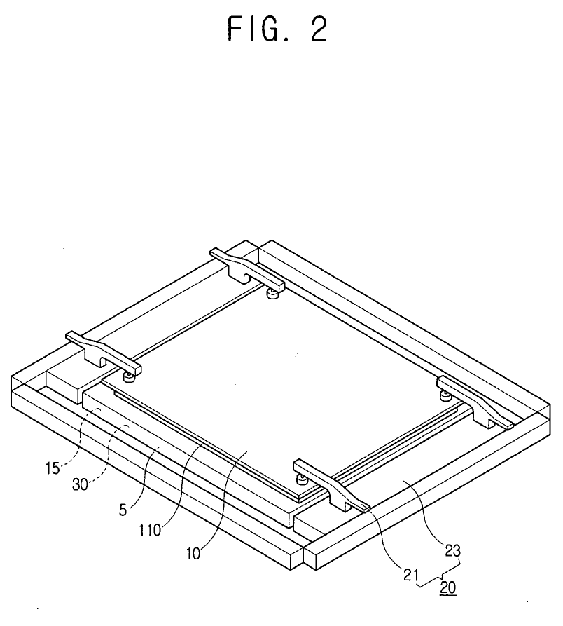

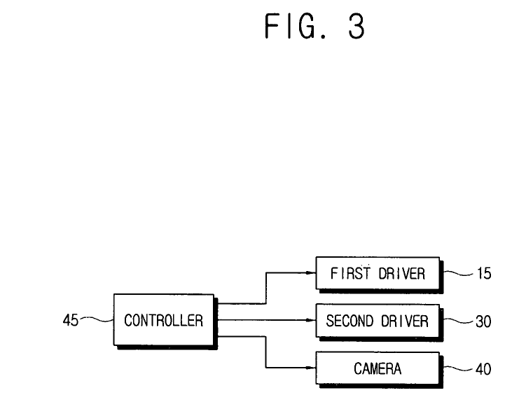

As shown in FIGS. 1 to 3, the manufacturing apparatus 1 of the display device according to the embodiment of the present invention comprises a stage 5 on which an insulating substrate 110 having an organic layer is seated; mold 10 which moves up and down above stage 5 and forms the uneven pattern on the organic layer; a first driver 15 which aligns and moves mold 10 upwards and downwards; a mold aligner 20 which holds and realigns mold 10 when molding mold 10 to the organic layer; a second driver 30 which drives mold aligner 20; a camera 40 which checks an alignment state of mold 10; and a controller 45 which controls the first and second drivers 15 and 30.

Stage 5 comprises a seating region on which insulating substrate 110 is seated, and has a rectangular shape. A plurality of lift pins (not shown) may be provided in stage 5 to support and move insulating substrate 110 up and down. The lift pins guide insulating substrate 110 introduced from the outside, to be seated on the seating region of stage 5.

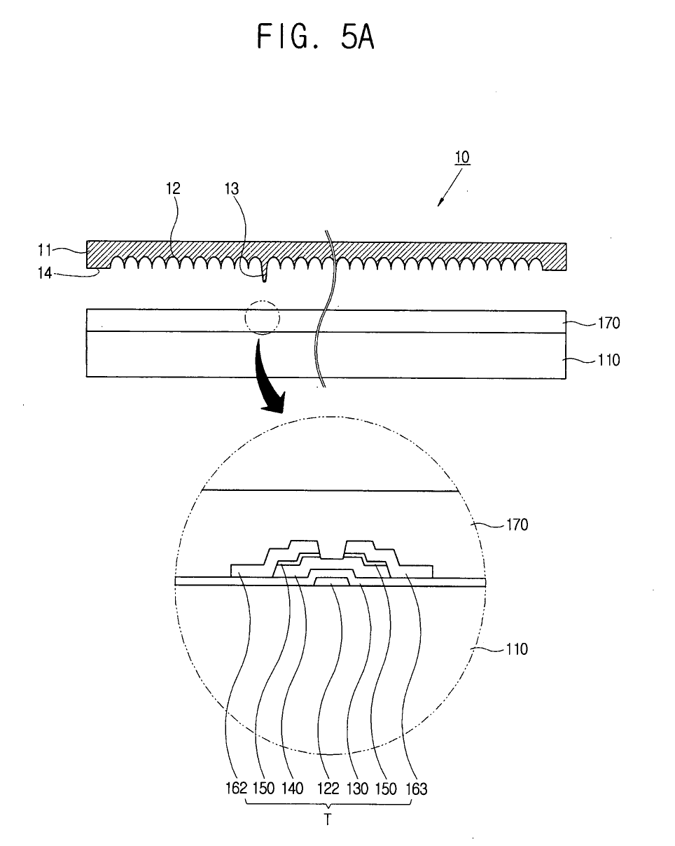

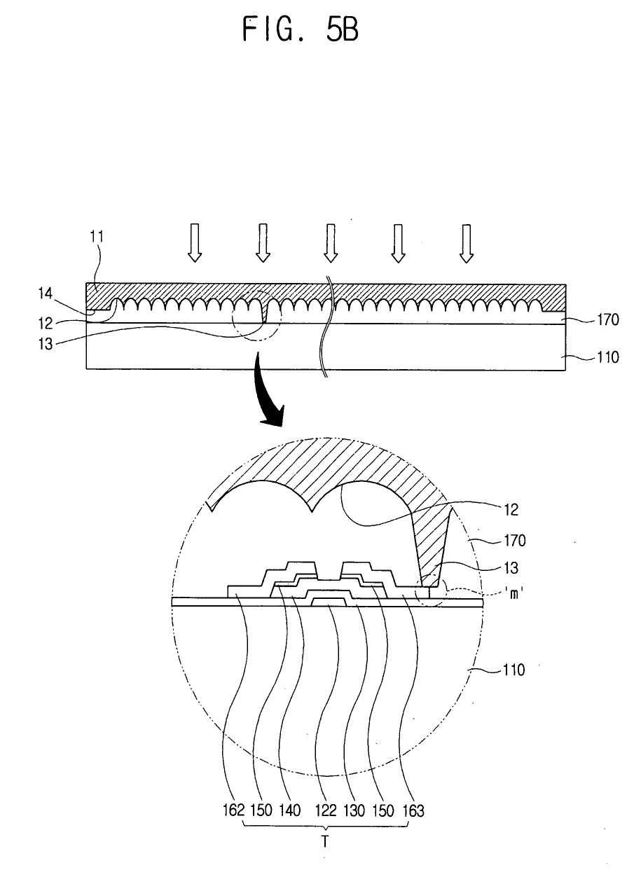

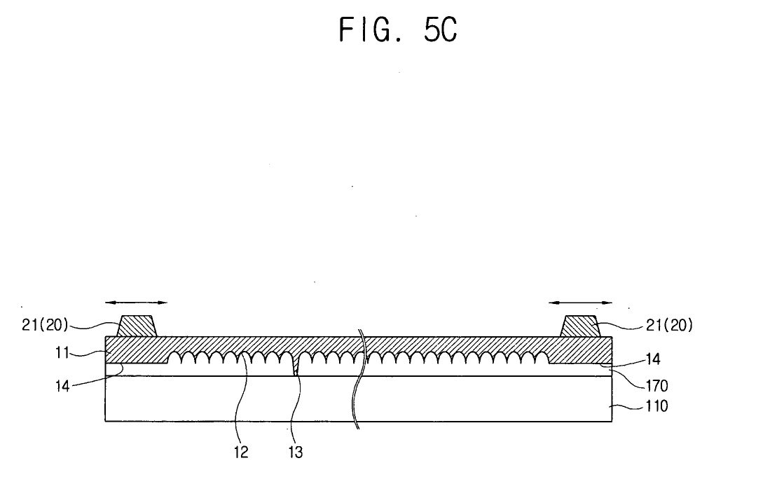

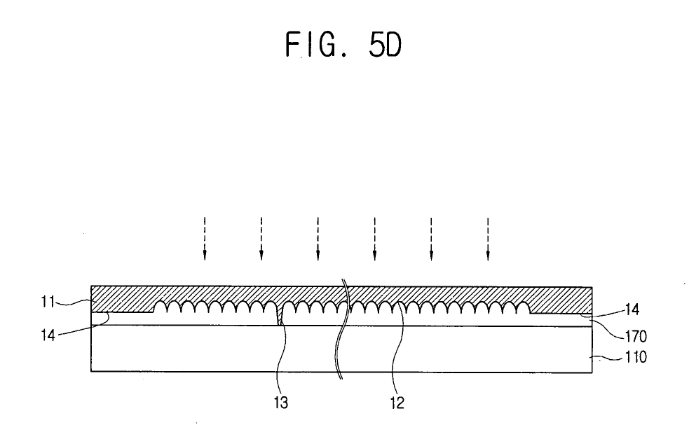

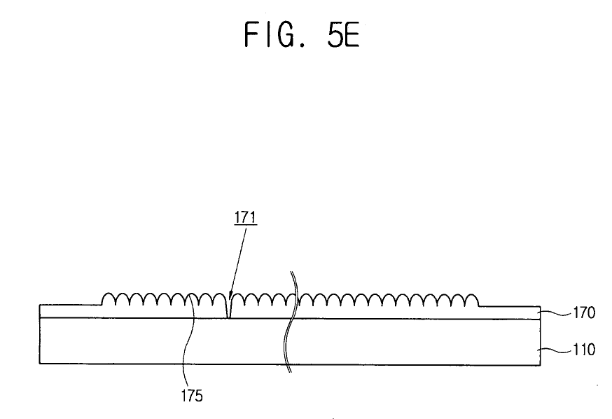

Mold 10 according to the present invention is provided on stage 10. In a reflection or a semi-transmission type LCD device, the uneven pattern is formed on the organic layer to allow a reflection layer to diffuse light and to increase reflection efficiency of light. As shown in FIG. 5A, mold 10 comprises a base layer 11; a pattern forming part 12 which is formed on a side of the base layer 11; and an even part 14 which is formed around pattern forming part 12. Pattern forming part 12 comprises a pattern corresponding to that to be formed on the organic layer. For example, pattern forming part 12 may comprise an uneven or embossing pattern as shown in FIG. 5A. Pattern forming part 12 comprises an organic layer removing part 13 which protrudes from the side having the uneven pattern. Organic layer removing part 13 presses a portion of the organic layer to remove the organic layer. Organic layer removing part 13 has a shape and a size corresponding to the portion to be removed. Organic layer removing part 13 may be provided on a predetermined position to correspond to a gate pad 123, a data pad 164 and a drain electrode 163 which are formed on insulating substrate 110. The uneven pattern is formed on the side of the base layer 11 as a concave shape. Organic layer removing part 13 is formed as a convex shape. An alignment key (not shown) is provided on mold 10 to be aligned on insulating substrate 110. Mold 10 may comprise a soft material to be in uniform contact with the organic layer and to be repeatedly used. Otherwise, mold 10 may comprise a transparent material transmitting ultraviolet rays. For example, mold 10 may comprise polydimethylsilixane (PDMS).

Mold 10 is moved by first driver 15. First driver 15 supports mold 10 which is moved to stage 5 by a robot, etc., and aligns mold 10 to form a pattern on a desired position. First driver 15 moves mold 10 up and down and forms the uneven pattern on the organic layer. That is, first driver 15 presses mold 10 toward insulating substrate 110 and forms the uneven pattern on the organic layer. After forming the uneven pattern, first driver 15 holds back mold 10 to separate mold 10 from the organic layer.

As the organic layer has fluidity, mold 10 may be distorted by the fluidity of the organic layer while being pressed to the organic layer and generates misalignment. The fluidity of the organic layer interferes with fine alignment, and accordingly decreases a yield of the pattern to be formed.

Manufacturing apparatus 1 of the display device according to the present invention comprises mold aligner 20 to realign mold 10 finely even if mold 10 is distorted by the fluidity of the organic layer while being pressed to the organic layer, thereby increasing the yield of the uneven pattern to be formed. That is, mold 10 is held and finely realigned by mold aligner 20 to form the desired pattern. The foregoing process is possible since the organic layer maintains its fluidity before being cured.

Mold aligner 20 according to the present invention comprises a holder 21 which holds mold 10; and a supporting frame 23 which supports holder 21. Holder 21 may comprise a vacuum chuck or a clamp. Holder 21 holds a second side of mold 10 which corresponds to the even part 14. As holder 21 holds the outside edge of the display region which displays an image, the restoration error due to an elastic force of the organic layer is minimized while finely aligning mold 10. Holder 21 may be rotatable to minimize an interruption with the insulating substrate 10 and first driver 15 while insulating substrate 110 is seated on stage 5 by first driver 15. That is, insulating substrate 110 is seated on stage 5 while holder 21 rotates to the outside of stage 5. Preferably, holder 21 may move upwards and downwards to hold the pressed mold 10. The supporting frame 23 is provided in the outside of stage 5 to support holder 21, and allows holder 21 to stably move.

In another embodiment of the present invention, an additional coupling part (not shown) may be provided on the second side of mold 10 to be coupled with holder 21 without difficulty.

The second driver 30 controls holder 21 to rotate and move upwards and downwards. The second driver 30 may comprise known devices to finely align mold 10.

Camera 40 is provided on stage 5 to check the alignment state of mold 10. Camera 40 may comprise a charged-coupled device (CCD), and check the alignment stage of alignment keys (not shown) on mold 10 and insulating substrate 110.

Controller 45 controls first driver 15, the second driver 30 and camera 40. Controller 45 controls first driver 15 to align mold 10 on insulating substrate 110. Controller 45 checks the alignment state between mold 10 and insulating substrate 110 using camera 40. After aligning mold 10, controller 45 drives first driver 15 to press mold 10 toward insulating substrate 110 and to form the uneven pattern on the organic layer corresponding to pattern forming part 12. Controller 45 checks through camera 40 again whether the misalignment is generated. When the misalignment is checked, controller 45 controls the second driver 30 to realign mold 10. More specifically, controller 45 checks the alignment state between mold 10 and insulating substrate 110 using camera 40, and calculates the moving direction and the moving distance mold 10. Controller 45 drives the second driver 30 to hold mold 10 through holder 21, and moves mold 10 according to a calculated value. Then, controller 45 rechecks the alignment state between mold 10 and insulating substrate 110 to inspect the realignment state therebetween. Controller 45 repeatedly performs the foregoing operations to minimize the alignment error due to the elastic force of the organic layer and to increase the yield of the pattern to be formed.

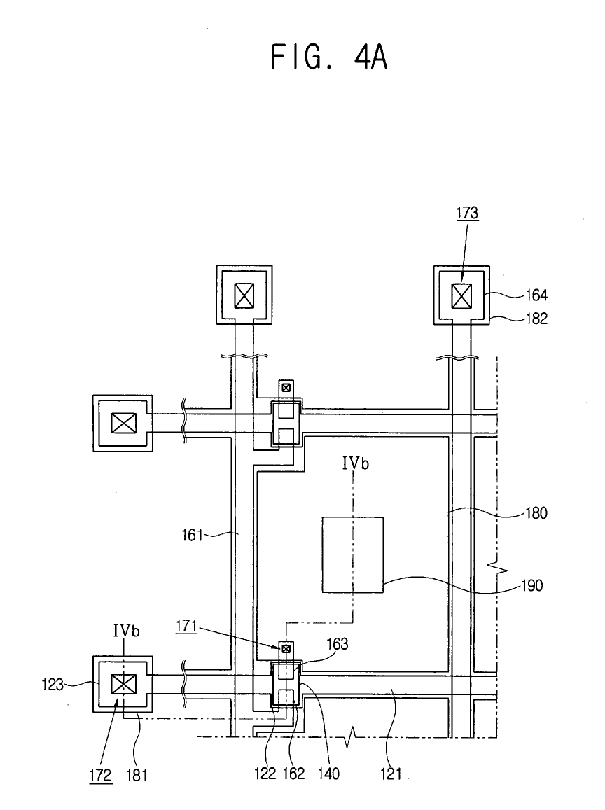

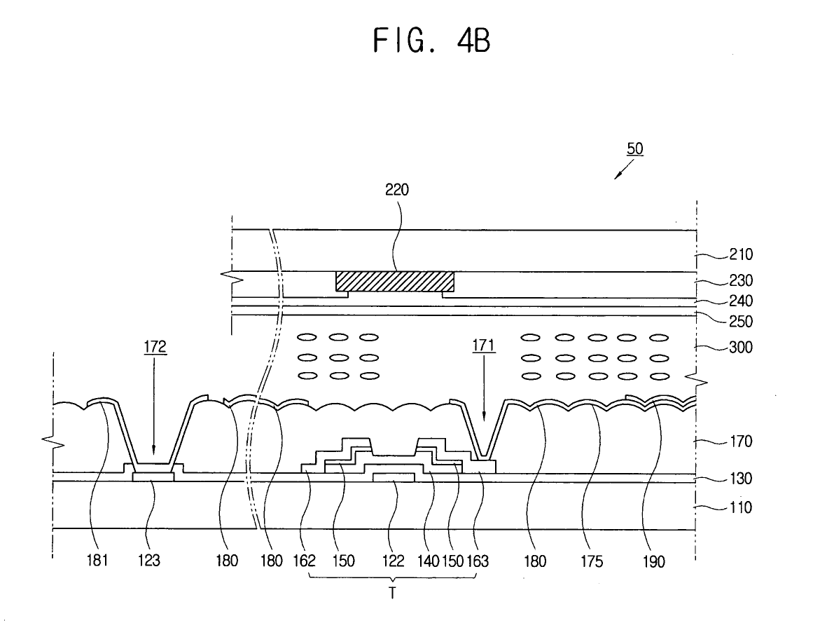

FIG. 4A is a layout diagram of a thin film transistor substrate according to the present invention. FIG. 4B is a sectional view of the thin film transistor substrate, taken along line IVb-IVb in FIG. 4A.

Generally, a liquid crystal display (LCD) device comprises a liquid crystal panel 50 that includes a thin film transistor substrate 100 (hereinafter, to be called a first substrate) having a thin film transistor (TFT) to control and drive pixels; a color filter substrate 200 (hereinafter, to be called a second substrate) which is adhered to substrate 100; and a liquid crystal panel 50 which has a liquid crystal layer 300 interposed between the thin film transistor substrate 100 and the color filter substrate 200.

Substrate 100 will be described in detail. Substrate 100 comprises a first insulating substrate 110; a plurality of gate wires 121, 122 and 123 and a plurality of data wires 161, 162, 163 and 164 which are formed on first insulating substrate 110 as a matrix; a thin film transistor T as a switching element which is formed on an intersection between gate wires 121, 122 and 123 and data wires 161, 162, 163 and 164; and a pixel electrode 180 which is connected with the thin film transistor T. The liquid crystal layer 300 is provided between the pixel electrode 180 and the color filter substrate 200 (to be described later) and receives a signal voltage through the thin film transistor T. The liquid crystal layer 300 is aligned through the signal voltage to determine light transmittance thereof.

First insulating substrate 110 may comprise a substrate which includes an insulating material such as glass, quartz, ceramic or plastic. Gate wires 121, 122 and 123 are formed on first insulating substrate 110. Gate wires 121, 122 and 123 may comprise a metal single or multi layer. Gate wires 121, 122 and 123 comprise a gate wire 121 which extends in a transverse direction; a gate electrode 122 which is connected with the gate wire 121; and a gate pad 123 which is provided on an end part of the gate wire 121 and connected with a gate driver (not shown) to receive a driving signal.

Gate insulating layer 130 which comprises silicon nitride (SiNx) covers gate wires 121, 122 and 123.

A semiconductor layer 140 comprising amorphous silicon and an ohmic contact layer 150 comprising n+amorphous silicon hydride highly doped with an n-type dopant are sequentially formed on gate insulating layer 130 corresponding to the gate electrode 122. A portion of the ohmic contact layer 150 is excluded on a channel area between the source electrode 162 and the drain electrode 163.

Data wires 161, 162, 163 and 164 are formed on the ohmic contact layer 150 and gate insulating layer 130. Data wires 161, 162, 163 and 164 may comprise a metal single or multi layer. Data wires 161, 162, 163 and 164 comprise a data wire 161 which insulatingly intersects the gate wire 121 and defines a pixel region; a source electrode 162 which is branched from the data wire 161 and extends to an upper part of the ohmic contact layer 150; the drain electrode 163 which is separated from the source electrode 162 and formed on the ohmic contact layer 150 opposite to the source electrode 162; and a data pad 164 which is formed on a an end part of the data wire 161 and connected with the data driver (not shown) to receive a video signal.

An organic layer 170 is formed on data wires 161, 162, 163 and 164 and semiconductor layer 140 exposed therebetween. Organic layer 170 comprises an uneven pattern 175, a drain contact hole 171 through which the drain electrode 163 is exposed, a gate pad contact hole 172 and a data pad contact hole 173 which are connected with the gate driver and the data driver to supply a driving signal to the gate wire 121 and the data wire 161. The uneven pattern 175 is formed on organic layer 170 to diffuse light and increase frontward reflection of light.

The pixel electrode 180 is formed on organic layer 170 having the uneven pattern 175. The pixel electrode 180 comprises a transparent conductive material such as indium tin oxide (ITO) or indium zinc oxide (IZO). The pixel electrode 180 is electrically connected with the drain electrode 163 through the drain contact hole 171. Contact auxiliary members 181 and 182 are formed on the gate pad contact hole 172 and the data pad contact hole 173. The contact auxiliary members 181 and 182 comprise a transparent conductive material such as indium tin oxide (ITO) or indium zinc oxide (IZO). Further, an uneven pattern on the pixel electrode 180 is formed by the uneven pattern 175 of organic layer 170.

A reflection layer 190 is formed on the pixel electrode 180. The pixel region defined by the gate wire 121 and the data wire 161 comprises a transmission region without reflection layer 190; and a reflection region on which reflection layer 190 is formed. The transmission region which does not comprise reflection layer 190 allows light to be transmitted from the backlight unit to the liquid crystal panel 50. The reflection region which comprises reflection layer 190 allows light from the outside to be reflected and emitted back to the liquid crystal panel 50. Reflection layer 190 comprises aluminum or silver, but not limited thereto. Reflection layer 190 may comprise a double layer of aluminum/molybdenum. Reflection layer 190 is formed on the pixel electrode 180 without being indented into the drain contact hole 171, and may receive a signal therefrom. The uneven pattern on reflection layer 190 is also formed by the uneven pattern of the pixel electrode 180.

Hereinafter, the color filter substrate 200 will be described in detail.

A black matrix 220 is formed on a second insulating substrate 210. Black matrix 220 divides a red filter, a green filter and a blue filter. Black matrix 220 prevents light from being directly emitted to the thin film transistor T which is formed on the first insulating substrate 100. Typically, black matrix 220 comprises a photosensitive organic material having a black pigment. The black pigment comprises carbon black or titanium oxide.

A color filter 230 comprises a red color filter, a green color filter and a blue color filter which are repeatedly provided between the black matrixes 220. The color filter 230 assigns color to light which is transmitted from the backlight unit to the liquid crystal layer 300. The color filter 230 comprises a photosensitive organic material.

An overcoat layer 240 is formed on the color filter 230 and a portion of black matrix 220 which is not covered by the color filter 230. The overcoat layer 240 makes the color filter 230 flat and protects the color filter 230. In general, the overcoat layer 240 comprises acrylic epoxy.

A common electrode 250 is formed on the overcoat layer 240. Common electrode 250 comprises a transparent conductive material such as indium tin oxide (ITO) or indium zinc oxide (IZO). Common electrode 250 supplies a voltage to the liquid crystal layer 300 together with the pixel electrode 180.

The liquid crystal layer 300 is formed between the first and second substrates 100 and 200.

Hereinafter, a manufacturing method of the display device using the manufacturing apparatus of the display device according to the embodiment of the present invention will be described with reference to FIGS. 5A to 5E.

FIGS. 5A to 5E illustrate the manufacturing method of the display device according to an embodiment of the present invention.

As shown in FIGS. 4A and 4B, gate wires 121, 122 and 123, gate insulating layer 130, semiconductor layer 140, the ohmic contact layer 150 and data wires 161, 162, 163 and 164 are formed on first insulating substrate 110 through known methods.

As shown in FIG. 5A, organic layer 170 is formed through a spin or slit coating. Organic layer 170 may comprise a polymer organic material, and be cured by at least one of heat and light (UV). Mold 10 having the uneven pattern is aligned on organic layer 170.

Mold 10 which is used to manufacture the liquid crystal display device according to the present invention comprises the base layer 11; pattern forming part 12 which is formed on a side of the base layer 11; and the even part 14 which is provided around of pattern forming part 12. The uneven pattern is formed on pattern forming part 12. At least one organic layer removing part 13 is formed on the part of the uneven pattern. The organic layer removing part 13 may be plurally provided. Pattern forming part 12 forms the uneven pattern on organic layer 170. The organic layer removing part 13 forms at least one of the drain contact hole 171, the gate pad contact hole 172 and the data pad contact hole 173 on organic layer 170, through which the drain electrode 163, the gate pad 123 and the data pad 164 are partially exposed, respectively. Here, at least one organic layer removing part 13 corresponds to at least one of the gate pad 123, the data pad 164 and the drain electrode 163.

As shown in FIG. 5B, controller 45 controls first driver 15 to press mold 10 toward organic layer 170 and to form the uneven pattern 175 on organic layer 170. Controller 45 checks through camera 40 whether mold 10 is misaligned due to the fluidity of organic layer 170. For example, the alignment error such as “m” may be generated by the fluidity of organic layer 170.

When the misalignment is checked, mold aligner 20 finely realigns mold 10. More specifically, holder 21 holds the circumference of mold 10. Controller 45 checks the alignment state between mold 10 and insulating substrate 110 through camera 40 (refer to FIG. 1) to finely realign mold 10. Holder 21 may comprise one of a vacuum chuck and a clamp. Holder 21 preferably holds the second side of mold 10 corresponding to the even part 14. Then, the restoration error due to the elastic force of organic layer 170 may be minimized. At least one organic layer removing part 13 is aligned to correspond to at least one of the gate pad 123, the data pad 164 and the drain electrode 163. Then, the yield of the pattern to be formed increases.

When it is checked that the realignment state is within allowable error range, organic layer 170 is cured while mold 10 is pressed, thereby maintaining the pattern formed on organic layer 170. Organic layer 170 may be cured through heat or light.

After curing organic layer 170, mold 10 is separated from organic layer 170 to complete the uneven pattern 175 and the drain contact hole 171, as shown in FIG. 5E. A release agent may be applied on mold 10 to be separated from organic layer 170 without difficulty.

When the organic 170 having the uneven pattern 175 is provided, ITO or IZO is deposited on organic layer 170 and the pixel electrode 180 is formed through an etching process as shown in FIGS. 4a and 4b. The pixel electrode 180 is connected with the drain electrode 163 through the drain contact hole 171. The pixel electrode 180 comprises the same pattern as the uneven pattern 175. Then, the contact auxiliary members 181 and 182 are formed, which are connected with the gate pad 123 and the data pad 164 through the gate pad contact hole 172 and the data pad contact hole 173, respectively.

After forming the pixel electrode 180, a reflection layer material is deposited on the pixel electrode 180 and then patterned to form reflection layer 190 on at least a portion of the pixel electrode 180. Reflection layer 190 is formed on the reflection region. Reflection layer 190 comprises the same pattern as the uneven pattern 175. Reflection layer 190 receives an electrical signal through the pixel electrode 180. The electrical signal is supplied to the liquid crystal layer 300 which is formed on reflection layer 190.

Then, an arrangement film (not shown) is formed to complete substrate 100 according to the embodiment of the present invention.

Through known methods, black matrix 220, the color filter 230, the overcoat layer 240, common electrode 250 and the arrangement film are formed on the second insulating substrate 210 to complete the second substrate 200. The first and second substrates 100 and 200 are adhered to each other and liquid crystals are supplied therebetween, thereby completing the liquid crystal panel 50.

As described above, the present invention comprises a manufacturing apparatus of a display device which increases a yield of a pattern formed on an organic layer, and a manufacturing method of a display device using the same.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. Apparatus for manufacturing a display device, comprising:
a stage on which an insulating substrate having an organic layer is seated;
a mold which moves up and down above the insulating substrate, and forms a pattern on the organic layer;
a first driver which aligns and moves the mold upwards and downwards;
a mold aligner which holds and realigns the mold while the mold is pressed to the organic layer;
a second driver which drives the mold aligner; and
a controller which controls the first and second drivers.

2. The manufacturing apparatus according to claim 1, wherein the mold aligner comprises a holder which holds the mold, and a supporting frame which supports the holder.

3. The manufacturing apparatus according to claim 2, wherein the holder comprises either a vacuum chuck or a clamp.

4. The manufacturing apparatus according to claim 3, further comprising:
a camera which checks an alignment state of the mold.

5. The manufacturing apparatus according to claim 4, wherein the mold comprises a pattern forming part which includes an uneven pattern on one side thereof, and an even part which is formed around the pattern forming part, wherein the holder holds a second side of the mold corresponding to the even part.

6. The manufacturing apparatus according to claim 4, wherein the controller controls the first driver to align the mold on the insulating substrate and presses the mold toward the insulating substrate.

7. The manufacturing apparatus according to claim 4, wherein the controller controls the second driver and realigns the mold while checking the alignment state of the mold by the camera.

8. The manufacturing apparatus according to claim 5, wherein the pattern forming part comprises at least one organic layer removing part which protrudes from the uneven pattern thereof.

9. The manufacturing apparatus according to claim 8, wherein a gate pad, a data pad and a drain electrode are provided between the insulating substrate and the organic layer, and
the controller aligns the mold to make the organic layer removing part to correspond to at least one of the gate pad, the data pad and the drain electrode.

10. The manufacturing apparatus according to claim 8, wherein the mold comprises an alignment key to be aligned on the insulating substrate.

11. A method of manufacturing a display device, comprising:
providing an insulating substrate which comprises an organic layer;
aligning a mold having a pattern forming part on the organic layer;
forming an uneven pattern on the organic layer corresponding to the pattern forming part by pressing the mold toward the insulating substrate;
holding and realigning the mold; and
separating the mold from the organic layer.

12. The method according to claim 11, further comprising:
curing the organic layer between the realigning the mold and the separating the mold.

13. The method according to claim 12, wherein the organic layer comprises a polymer organic material and cured by at least one of heat and light.

14. The method according to claim 12, further comprising:
using a camera which checks an alignment state of the mold.

15. The method according to claim 14, wherein the mold aligner comprises a holder for holding a circumference of the mold and aligning the mold while the camera is checking the alignment state of the mold.

16. The method according to claim 15, wherein the holder comprises either a vacuum chuck or a clamp.

17. The method according to claim 16, wherein the mold comprises the pattern forming part which includes an uneven part on a side thereof, and an even part which is provided around the pattern forming part, and the holder holds a second side of the mold corresponding to the even part.

18. The method according to claim 15, before forming the organic layer:
forming a gate wire which extends in a predetermined direction, and a data wire which insulatingly intersects the gate wire and defines a pixel region on the insulating substrate; and
forming a thin film transistor on an intersection of the gate wire and the data wire.

19. The method according to claim 18, wherein the pattern forming part comprises at least one organic layer removing part which protrudes the uneven pattern,
the gate wire comprises a gate pad, and the data wire comprises a data pad and a drain electrode, and
the realigning the mold comprises realigning the mold to make the organic layer removing part correspond to at least one of the gate pad, the data pad and the drain electrode.

20. The method according to claim 19, after curing the organic layer, further comprising:
forming a pixel electrode corresponding to the pixel region on the organic layer, and
forming a reflection layer on at least a portion of the pixel electrode.
